(19) United States
(12) Patent Application Publication
(10) Pub. No.: US 2004/0053004 A1
(43) Pub. Date: Mar. 18, 2004

(54) Tube mat

(75) Inventors: Bernd Pahl, Hamburg (DE); Helmuth Blank, Seevetal (DE)

Correspondence Address: WILLIAM COLLARD, COLLARD & ROE, P.C., 1077 NORTHERN BOULEVARD, ROSLYN, NY, 11576, US

(73) Assignee: Phoenix AG

(21) Appl. No.: 10/644,128

(22) Filed: Aug. 20, 2003

Related U.S. Application Data
(62) Division of application No. 09/857,920, filed on Jun. 11, 2001, now Pat. No. 6,649,237.
Application No. 09/857,920 is a 371 of international application No. PCT/DE00/03289, filed on Sep. 21, 2000.

(30) Foreign Application Priority Data
Oct. 18, 1999 (DE) 199 50 253.6

(51) Int. Cl. B32B 5/00

(52) U.S. Cl. 428/98

(57) ABSTRACT

The invention relates to a tube mat (1) made of elastomer material in the form of an extruded product, comprising at least

a first face side and a second face side, which are arranged perpendicular or at an angle in relation to the direction of extrusion; as well as

a plurality of tubes (2) extending between the two face sides parallel with the direction of extrusion.

The tube mat (1) as defined by the invention is characterized in that

at least a part of the tube are closed at adjustable intervals, specifically with formation of an enclosed air column in each case, whereby the tube closure forms a one-piece elastomer composite with the tube mat.

Furthermore, introduced is a method for producing the tube mat (1) as defined by the invention. According to the method, following extrusion, the tubes are pressed shut in points with the help of a pressure applicator roller that is provided with pins distributed over the circumference of the roller, specifically with formation of beads (5) and closing bridges (6). The vulcanization is carried out subsequently.

### DESCRIPTION

The invention relates to a tube mat made of elastomer material in the form of an extruded product, comprising at least

a first face side and a second face side, which are arranged perpendicular or at an angle in relation to the direction of extrusion, as well as

a plurality of tubes extending between the two face sides parallel with the direction of extrusion.

A tube mat of the type specified above is described, for example in the published documents DE-C-33 45 388; DE-C-34 03 234; DE-C-35 24 719; and EP-B-0 569 867.

In conjunction with the tube mats known until now, it was possible for dirt and water to penetrate the tube mat on the face sides, which then frequently led to the fact that the tube mat was no longer capable of fully satisfying its function with respect to its elasticity.

Now, the problem of the invention is to provide a tube mat in connection with which the penetration of dirt and water is excluded to the greatest possible extent, combined with an improvement of the elastic properties of the article and, at the same time, a longer useful life, all this under permanent dynamic stress.

Said problem is solved in that at least a part of the tubes are closed at adjustable intervals, specifically with formation of an enclosed air column in each case, whereby the closure of the tube forms a one-piece elastomer composite with the tube mat.

The closure of the tube may extend in this connection in one line perpendicular or at an angle unequal to 90° in relation to the direction of extrusion, preferably at an angle of from 45° to 80°.

Particularly the following two variations are employed with respect to the tube closure:

The first and the second face sides of the tube mat are closed, specifically with formation of a completely sealed tube system.

The first and/or the second face side(s) are/is partially or completely open, specifically with formation of a correspondingly open face zone. However, a sealed tube system is present in the center zone of the tube mat.

The following materials are usefully employed for the tube mat:

The tube mat consists of a vulcanized rubber mixture based on ethylene-propylene-diene copolymer (EPDC), whereby the hardness in Shore A amounts to 30° to 50°.

The alternative material is a vulcanized rubber mixture based on natural rubber (NR), whereby the hardness in Shore A amounts to 30° to 60° in the present case.

Additional mixing ingredients usually contained in the rubber mixture are, for example sulphur or sulphur donors, accelerators, zinc oxide, fillers and anti-aging agents.

The tube mat as defined by the invention is applied particularly in the field of rail traffic technology, specifically within the framework of vibration and sound damping in the following areas of application:

The tube mat serves as an elastic mat in the railroad bed or ballast. Under this aspect, the tube mat is referred also as a railroad bed mat or below-ballast mat. The mat may be covered in this connection by a protective layer of fleece or the like, if need be.

The tube mat has the function of an elastic insert in crosstie systems.

Furthermore, the tube mat serves as an elastic substrate in rail support sites, in particular again in the form of a rail substrate that is arranged underneath the foot of the rail.

Furthermore, the problem of the invention is to provide for the tube mat of the type described above a method that assures a safe closure of the tubes, and which is economical.

A particularly advantageous method for producing the tube mat as defined by the invention is characterized by the following steps of the method:

Following extrusion, the tubes are pressed shut with the help of a pressure applicator roller that is provided with pins which are distributed over the circumference of the roller, specifically with the formation of beads or closing bridges; and

vulcanization is carried out subsequently.

Other advantageous parameters of the method are introduced in the following within the framework of the description of the figures. In the drawing,

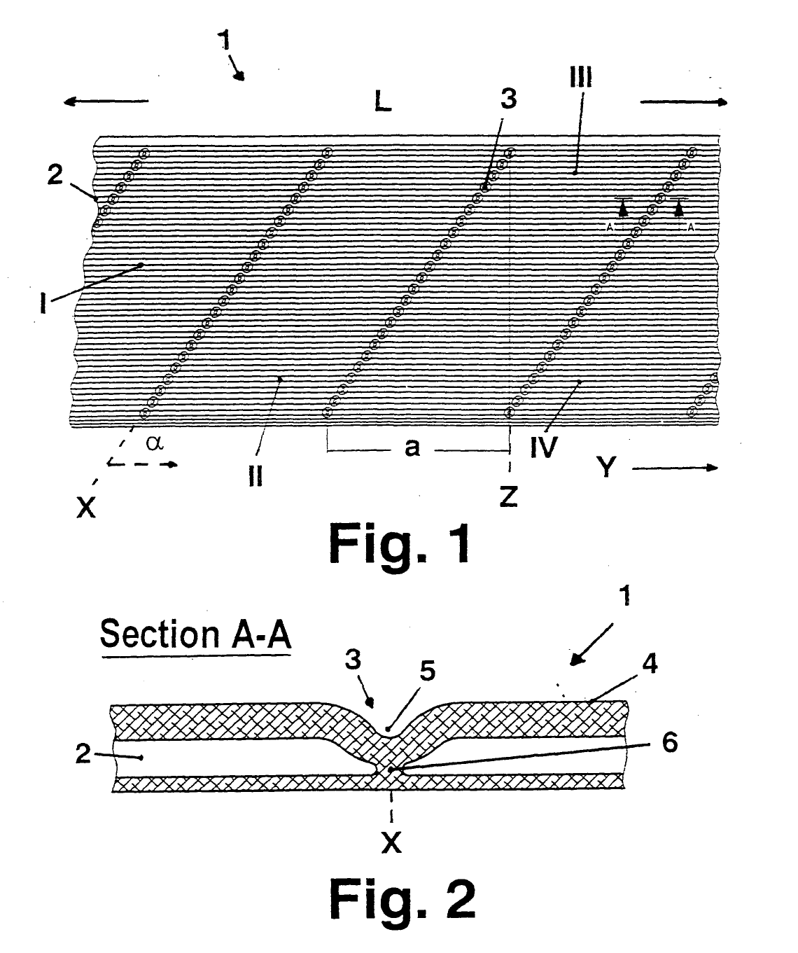

FIG. 1 shows a tube mat with closure of the tubes along lines at an angle unequal to 90° in relation to the direction of extrusion.

FIG. 2 shows details of the tube closure according to section line A-A in FIG. 1.

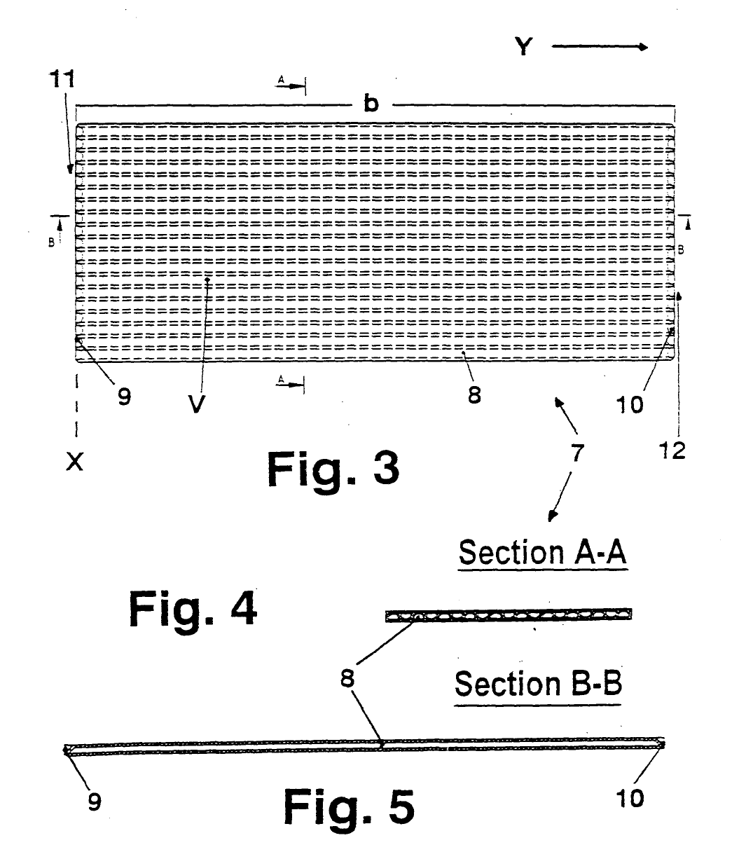

FIG. 3 shows a tube mat with closure of the tubes along a line perpendicular to the direction of extrusion.

FIG. 4 shows a tube mat according to section line A-A in FIG. 3.

FIG. 5 shows a tube mat according to section line B-B in FIG. 3; and

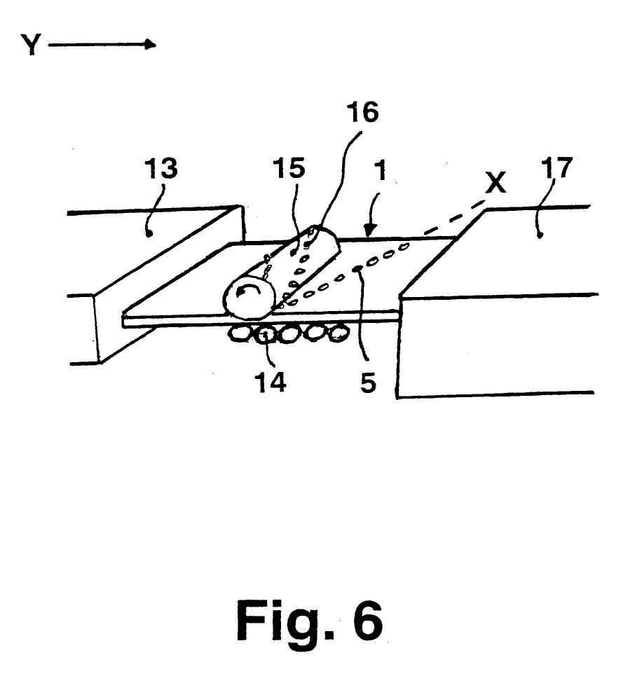

FIG. 6 shows a diagram illustrating the manufacture of a tube mat according to FIG. 1.

The following list of reference numerals applies in connection with said figures:

1 Tube mat

2 Tubes

3 Tube closure

4 Top side of tube mat

5 Bead

6 Bridge of closure

7 Tube mat

8 Tubes

9 Tube closure

10 Tube closure

11 First face side of the tube mat

12 Second face side of the tube mat

13 Extruder with outlet opening

14 Support rollers

15 Pressure applicator roller

16 Pins

17 Vulcanization channel

FIG. 1 shows a tube mat 1 made of elastomer material, i.e. of rubber or a material similar to rubber. Said tube mat is an extruded product with the extrusion direction “Y”. A length “L” of up to 100 m is realizable in this connection.

The tube mat 1 has a plurality of tubes 2 extending parallel with the extrusion direction “Y”. The tubes are closed in this connection at the adjustable intervals “a”, specifically with formation of an enclosed air column in each case. In the present case, the tube closure 3 extends in a line “X” at an angle “∝” of about 55° in relation to the extrusion direction “Y”. A plurality of closed tube segments I, II, III and IV are produced in this way.

Now, the following two possibilities are available within the framework of a cut through the article:

The cut is made along line “X” through the center of the tube closure 3. This produces a face side of the tube mat that is completely closed.

The cut is made along line “Z” perpendicular to the extrusion direction “Y”. This produces a tube segment III that is open within the face side of the tube mat. This, however, can be accepted if the tube mat has at least one closed tube segment, in particular a plurality of closed tube segments connected in series. This is the case also when the tube mat 1 is employed as a railroad bed mat, or below-ballast mat.

FIG. 2 shows the tube closure 3, whereby a bead 5 is formed on the top side 4 of the tube mat 1 within the zone of the closure. The tube closure as such is caused by the closing bridge 6.

Now, if the article is cut along the line “X” through the center of the closing bridge 6, a closed face side of the tube mat 1 is produced.

FIG. 3 shows a tube mat 7 with the tubes 8. In the manufacture of said tube mat, which is initially produced in the form of a web-shaped structure, several tube closures 9, 10 are formed which, as opposed to the exemplified embodiment according to FIG. 1, extend in a line “X” perpendicular to the extrusion direction “Y”. The tubes 8 are closed in this connection at an adjustable interval “b”, specifically with formation of a closed tube segment “V”.

Now, within the framework of said exemplified embodiment, the article is cut along the line “X”, whereby a first face 11 and a second face side 12 are formed, which each are completely closed. Only one single closed tube segment V is present in this connection.

Such a tube mat is employed, for example as an elastic insert in crosstie shoe systems.

FIG. 4 shows the cross section (A-A) of the tube mat 7 according to FIG. 3, whereby the tubes 8, viewed in the cross section, substantially have the shape of a semicircle specifically in an alternative arrangement of the structure. However, tubes with another cross sectional shape (e.g. circular) are possible as well.

Now, FIG. 5 shows a longitudinal section (B-B) through the tube mat 7 according to FIG. 3, specifically with formation of a closed tube 8. The same applies with respect to the tube closure 9, 10 as to the tube closure 3 according to FIG. 2.

Now, FIG. 6 describes the technical sequence of the method for producing a tube mat 1 according to FIG. 1.

The web-shaped tube mat 1 exits from the extruder 13 in the extrusion direction “Y”. The tube mat is now guided on a supporting sliding system particularly in the form of the support rollers 14. A pressure applicator roller 15, which is provided with the pins 16 distributed over the circumference of the roller, now presses the tubes shut in points (i.e. exclusively within the zone of the closure), specifically with formation of the beads 5 and the closing bridges 6 (FIG. 2). The tube closure 3 (FIGS. 1, 2) extends in this connection in a line “X” at an angle unequal to 90°.

The tube mat 1 then enters a vulcanization channel 17. The vulcanization is carried out without pressure in this connection in the UHF-channel, in a salt bath installation, or in a hot air installation.

The pins 17 are advantageously exchangeable. Pins with a diameter of, for example 20 mm have been successfully used in connection with railroad bed mats or below-ballast mats.

With another arrangement principle of the pressure applicator roller 15 and the pins 16 it is possible also to realize a tube closure 3 that extends in a line “X” perpendicular to the extrusion direction “Y”.

1. A tube mat (1, 7) made of elastomer material in the form of an extruded product comprising at least
a first face side and a second face side (11, 12) arranged perpendicular to or at an angle in relation to the extrusion direction (Y); as well as
a plurality of tubes (2, 8 extending between the two face sides (11, 12) parallel with the extrusion direction (Y);
characterized in that a part of the tubes (2, 8) are closed at adjustable intervals (a, b), specifically in each case with formation of an enclosed air column, whereby the tube closure (3, 9, 10) forms a one-piece elastomer composite with the tube mat (1, 7).

2. The tube mat according to claim 1, characterized in that the tube closure (9, 10) extends in a line (X) perpendicular to the extrusion direction (Y).

3. The tube mat according to claim 1, characterized in that the tube closure (9, 10) extends in a line (X) at an angle ∝ unequal to 90°, preferably at an angle of from 45° to 80° in relation to the extrusion direction (Y).

4. The tube mat according to any one of claims 1 to 3, characterized in that the first and the second face sides (11, 12) are closed, specifically with formation of a completely closed tube system.

5. The tube mat according to any one of claims 1 to 3, characterized in that the first and/or the second face sides are partially or completely open, specifically with formation of a correspondingly open face area; however, with formation of a closed tube system in the center area of the tube mat.

6. The tube mat according to any one of claims 1 to 5, characterized in that the mat consists of a vulcanized rubber mixture based on ethylene-propylene-diene copolymer (EPDC).

7. The tube mat according to claim 6, characterized in that the hardness in Shore A amounts to 30° to 50°.

8. The tube mat according to any one of claims 1 to 5, characterized in that the mat consists of a vulcanized rubber mixture based on natural rubber (NR).

9. The tube mat according to claim 8, characterized in that the hardness in Shore A amounts to 30° to 60°.

10. The tube mat according to any one of claims 1 to 9, in particular in association with claims 3 and 5, for use as an elastic mat in the railroad bed or ballast, whereby the mat is covered with a protective layer of fleece or the like, if necessary.

11. The tube mat according to any one of claims 1 to 9, in particular in association with claims 2 and 4, for use as an elastic insert in crosstie shoe systems.

12. The tube mat according to any one of claims 1 to 9, in particular in association with claims 2 and 4, for use as an elastic substrate in rail support sites, in particular in the form of a rail substrate arranged underneath the foot of the rail.

13. A method of producing a tube mat according to any one of claims 1 to 12, characterized by the following steps of the method:
Following extrusion, the tubes are pressed shut within the area of the closure with the help of a pressure applicator roller (15) provided with pins (16) distributed over the circumference of the roller, specifically with formation of beads (5) and closing bridges (6);
vulcanization is carried out subsequently.

14. The method according to claim 13, characterized in that exchangeable pins (16) are used.

15. The method according to claim 13 or 14, characterized in that the vulcanization is carried out without pressure in the UHF channel, in a salt bath installation, or in a hot air installation.

16. The method according to any one of claims 13 to 15, characterized in that the tube mat (1, 7) is produced with a great length specifically with formation of closed tube segments (I, II, II, IV, V), in conjunction with subsequent cutting of the article depending on the purpose of application.
